(19) United States
(12) Patent Application Publication
(10) Pub. No.: US 2012/0294011 A1
(43) Pub. Date: Nov. 22, 2012

(54) METHOD FOR ATTACHING AN OPTICAL LENS TO A PRINTED CIRCUIT BOARD WITH ELECTRONIC LIGHT SOURCE

(75) Inventors: Don Cattoni, Huntersville, NC (US); Jeffrey D. Harman, SR., Salisbury, NC (US)

(73) Assignee: Shat-R-Shield, Inc., Salisbury, NC (US)

(21) Appl. No.: 13/473,427

(22) Filed: May 16, 2012

Related U.S. Application Data
(60) Provisional application No. 61/486,716, filed on May 16, 2011.

(51) Int. Cl. F21V 5/04; B29C 65/52; B29C 65/02; F21V 21/00

(52) U.S. Cl. 362/311.02; 362/455; 156/60

(57) ABSTRACT

The present invention relates to a LED assembly and method for attaching an optical lens to a printed circuit board having an electronic light source such as an LED or OLED, by application of an adhesive comprising silicone or an epoxy and heat curing the adhesive material at a low temperature.

### CROSS-REFERENCE TO RELATED APPLICATIONS

This application claims priority from U.S. Provisional Patent Application No. 61/486,716, filed on May 16, 2011, incorporated herein by reference in its entirety.

### FIELD OF THE INVENTION

The present invention generally relates to a method for attaching an optical lens with or without a lens holder to a printed circuit board having an electronic light source and to the resulting assembly.

### BACKGROUND OF THE INVENTION

There are many types of electronic light sources including, for example, light-emitting diodes (LEDs) and organic light-emitting diodes (OLEDs), that are present on printed circuit boards. LEDs emit light at wide dispersed angles between 120 and 130 degrees. There are numerous applications where the light needs to be collimated and dispersed into different light angles and focus depths. There are a large variety of different types of lenses for all of the different styles and shapes of LEDs. A current method of attachment of the lenses to the LEDs is with non-ultra violet resistant adhesives or self-adhesives. These adhesives typically do not last more than a couple of years. These adhesives have to be manually dispensed and cannot be applied with precision. Because the adhesive is dispensed manually the variation in the process is greatly increased and the control of the process is greatly diminished. The pressure to squeeze the dispensing applicator varies by the person from application to application and from person to person. The human interaction greatly increases the variation. If adhesive gets on the LED or migrates onto the LED during the application of the lens, this can have a detrimental effect on the performance of the lens. This is a very labor intensive process with mixed results and undetermined long term adhesion. Thus, there is a need for a way of automating a process to precisely dispense an adhesive around an LED to attach the lens without the adhesive migrating on to the LED surface. The present invention addresses and overcomes these problems.

### SUMMARY OF THE INVENTION

The present invention relates to an optical assembly and a method for attaching an optical lens with or without a lens holder to a printed circuit board having an electronic light source such as a light-emitting diode, by application of an adhesive comprising an epoxy or a silicone and optional low-temperature heat cure.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 illustrates a known LED assembly.

FIG. 2 illustrates a known LED assembly.

FIG. 3 illustrates the lens holder of FIG. 2.

FIG. 4 illustrates a known LED assembly and method of “snapping” a lens holder onto a LED package.

FIG. 5 illustrates the lens holder of FIG. 4 attached over the LED package without the use of an adhesive.

FIG. 6 illustrates a LED assembly within the scope of the present invention.

FIG. 7 is a close-up side view of an LED assembly within the scope of the present invention.

FIG. 8 is a process flow diagram of a process(es) within the scope of the present invention.

### DETAILED DESCRIPTION OF THE INVENTION

The following detailed description of the embodiment(s) is merely exemplary in nature and is in no way intended to limit the invention, its application, or uses.

The present invention relates to a method, preferably an automated or computerized method or process, for dispensing an adhesive material and for attaching an optical lens(es) to a printed circuit board(s) having an electronic light source such as a light-emitting diode (LED) or organic light-emitting diode (OLED), interchangeably referred to herein as a LED, using an adhesive material.

The adhesive material of the present invention comprises a silicone, an epoxy, or a combination thereof. The adhesive material acts as a long term, non-degrading adhesive to bond an external optical lens over a LED and offers protection from detrimental environmental factors such as moisture and contaminants.

Features of a desirable silicone adhesive include, but are not limited to, 1-part component electrically insulating, opaque, excellent adhesion to attach plastic LED lenses and lens holders onto printed circuit boards and plastic substrates, flexible silicone that is heat curable below 230° F. (110° C.) to avoid any heat distortion to all types of lenses and lens holders, thick material having a viscosity in a range of about 50,000 centipoise to 70,000 centipoise to allow for a bead to be dispensed around the LED to attach a secondary lens or lens holder, excellent adhesion of lens and lens holders to all types of printed circuit boards and offers very good protection from moisture and environmental contaminants. Examples of commercially available silicone adhesives for use in the present invention include, but are not limited to, Dow 737 or 738 silicone sealant, Shin-Etsu IO-Seal-300, and Humiseal R1-2145. Preferably, the silicone adhesive material composition comprises a crystalline silica, an organopolysiloxane or mixture thereof, or a combination thereof. The organopolysiloxane may be a straight-chain organopolysiloxane.

The silicone adhesive material is low temperature curable, preferably at or below 230° F. (110° C.) and for a time period of about an hour or less, due to the possibility of deforming plastic lens holders or lenses. The adhesive material in accordance with the present invention secures the lens or lens holder for the life of the product and is not affected by Ultra Violet (UV) light. The silicone adhesive material also offers excellent shock absorption.

Features of a desirable heat curable epoxy adhesive include, but are not limited to, 1-part component electrically insulating, opaque, epoxy material having a viscosity in a range of about 15,000 centipoise to 35,000 centipoise (thick paste material for dispensing out of the selective coating equipment which contains computer programmed and controlled needle dispensing valves), hard epoxy that is heat curable at a lower time and temperature (such as 7 to 15 minutes at 100° C.) to avoid any heat distortion to all types of lenses and lens holders, white to grey in color, very strong and tough, shear strength greater than 5.0 MPa tested using method NFT 76107, excellent adhesion of lens and lens holders to all types of printed circuit boards and offers very good protection from moisture and environmental contaminants. An example of a commercially available epoxy adhesive suitable for use in the present invention is Protavic ATE 10120 from Protavic America Inc. Thermally conductive epoxies from Ellsworth, Masterbond, Dow Corning, and Polymark, Inc. may also be suitable.

An adhesive material suitable for use in the present invention is precisely dispensed around the LED with robotic or other computer programmable automated selective dispensing equipment, preferably the dispensing equipment having precision needle valves, to seal the edges of the LED to a printed circuit board and to provide enough material to bond the optical lens or optical lens holder but yet not too much material so as to cause it to migrate onto the LED when the lens or lens holder is attached. The lens or lens holder may be applied by hand. The adhesive material is applied by a robotic or other computer programmable, selective dispensing equipment or machine. The size of the needle dispensing valves are determined by the type of material and the amount of material to be dispensed. Additionally, there are various types of needle dispensing valves that are suitable for use in accordance with the method of the present invention including pressurized dispensing needle valves. By controlling the rate that the needle moves across the printed circuit board and the air pressure dispensing the adhesive, the process variation as compared to manual methods is greatly reduced providing a very high degree of process control. The computer controlled needle dispensing valves such as on the Asymtek 940 are typically programmed to dispense the material with a speed range of about 4 inches per second to 6 inches per second and with a pressure range of about 65 lbs to 75 lbs.

Examples of commercially available dispensing equipment include, but are not limited to, Asymtek 940 (using DV05 pressurized dispensing needle), and PVA6000 (using FC100 high pressure dispensing valve) from Precision Valve and Automation.

Potential end-use applications include, but are not limited to, all LED printed circuit boards that need to have secondary optical lenses attached.

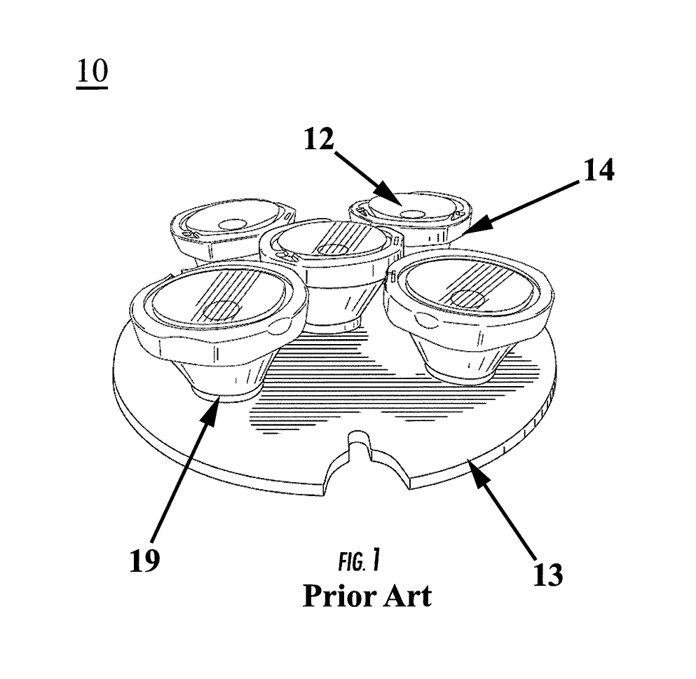

Referring to the Figures, FIG. 1 illustrates a known LED assembly (10) comprised of a LED (not shown) mounted to a printed circuit board (13) with multiple lens holders (14) and lenses (12) attached over an LED (not shown). FIG. 1 illustrates attachment by a snap fit that has manufacturing variances which alter the holding strength of the attached lens. In this assembly, a conformal coating (19) is used as opposed to an adhesive. A conformal coating refers to a dielectric material that is applied to electronic circuitry to act as protection against moisture, dust, chemicals, and temperature extremes that if uncoated (non-protected) could result in a failure of the electronic system. The conformal coating (19) does not supply adequate strength to secure the lens (12) or lens holder (14) to the printed circuit board (15). In end use applications where there is a lot of vibrations and shock, the lens or lens holder can vibrate loose and fall off. As shown in FIG. 1, the lens holders (14) are cone shaped and clear lenses (12) are mounted inside the lens holders (14). Thus, FIG. 1 illustrates an inferior method and LED assembly as compared to the present invention.

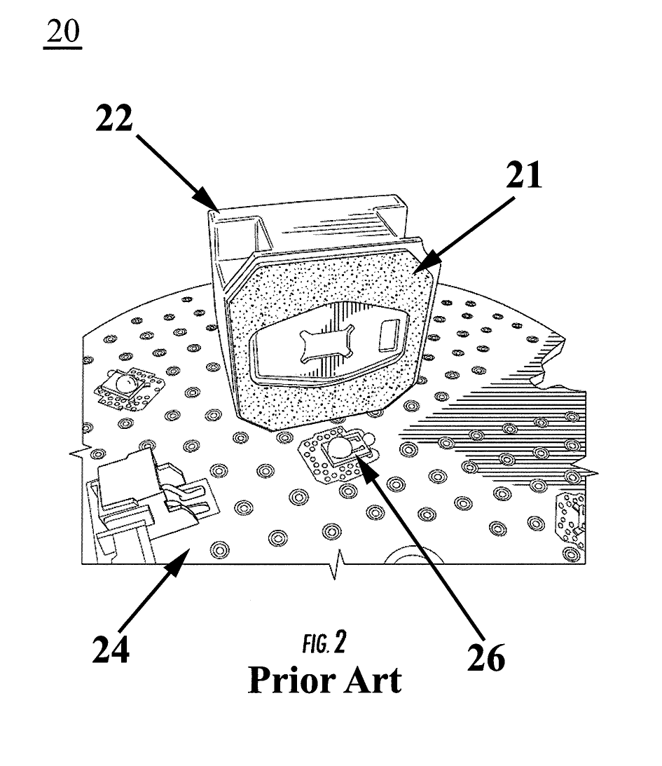

FIG. 2 illustrates a known LED assembly (20) and method of using a lens holder (22) having a self-adhesive material (21) that comes with a peel off protective backer (not shown). To install the lens holder (22) onto the printed circuit board (24), the backer is peeled off which exposes the self-adhesive material (21) and the lens holder (22) is pressed onto the printed circuit board (24) over the LED (26). A problem exists with this LED assembly (20) and method of attachment in that the self-adhesive material (21) does not hold on the lens or lens holder and over time loses its strength such that the lens or lens holder falls off. As FIG. 2 illustrates, the self-adhesive material (21) of the lens holder (22) has a low bonding strength and softens with the heat generated from the LED (26) while in operation and breaks loose. Any type of contamination on the board can have a further negative effect on the adhesive strength.

There are many other types of lens holders and lenses that require extremely tight fit around the LED package. These tight specifications leave no room for variation in the manual application of liquid adhesives. The lens holder interface with the LED package is an exact fit without any space between the two components when they are assembled. When liquid adhesives are applied by hand and the lens is attached, the material can easily migrate over the LED (26) and have detrimental effects on the light output. In contrast to the LED assembly and method of FIG. 2, the method of the present invention precisely applies a predetermined amount of adhesive material and to particular areas, thereby eliminating this problem.

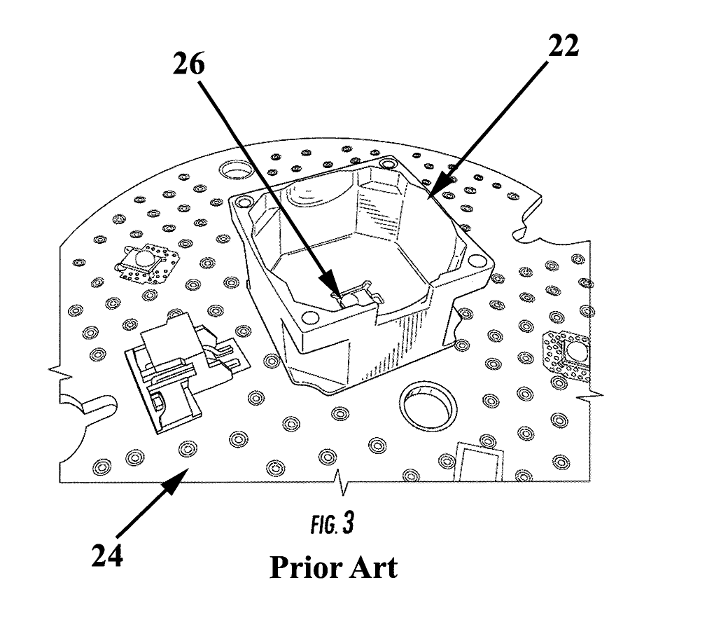

FIG. 3 illustrates the lens holder (22) from FIG. 2 attached to the printed circuit board (24) over the LED (26). As shown, there is not much clearance room, if any.

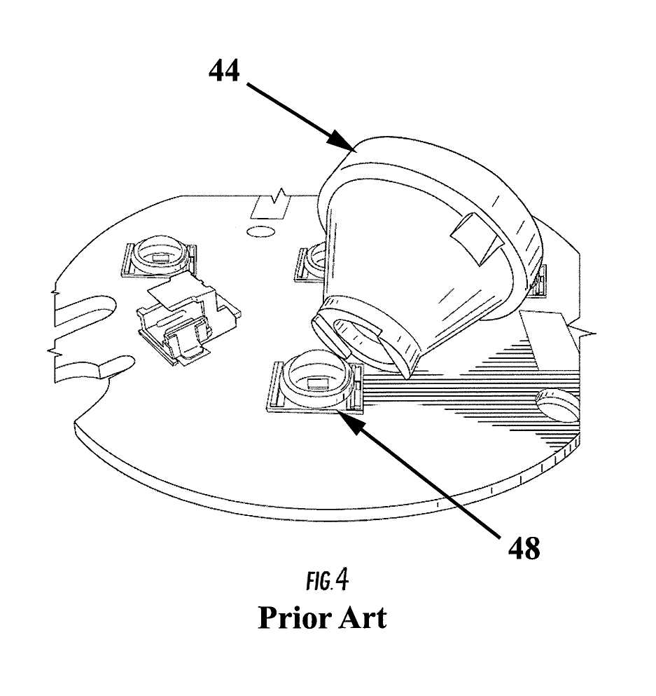

FIG. 4 illustrates a known LED assembly and method of “snapping” a lens holder (44) onto a LED package (48). It does not offer good holding power because of the different tolerances in manufacturing. A lens holder (44) is easily jarred or knocked off. FIG. 4 illustrates the interface of the lens holder (44) and the LED package (48).

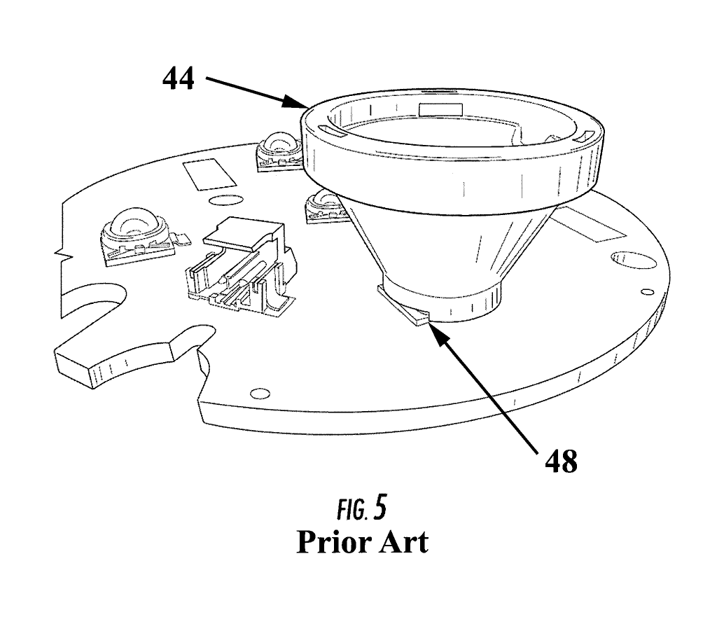

FIG. 5 illustrates how the lens holder (44) of FIG. 4 is attached over the LED package (48) without the use of any adhesives. There is not any protection from moisture or environmental contaminants.

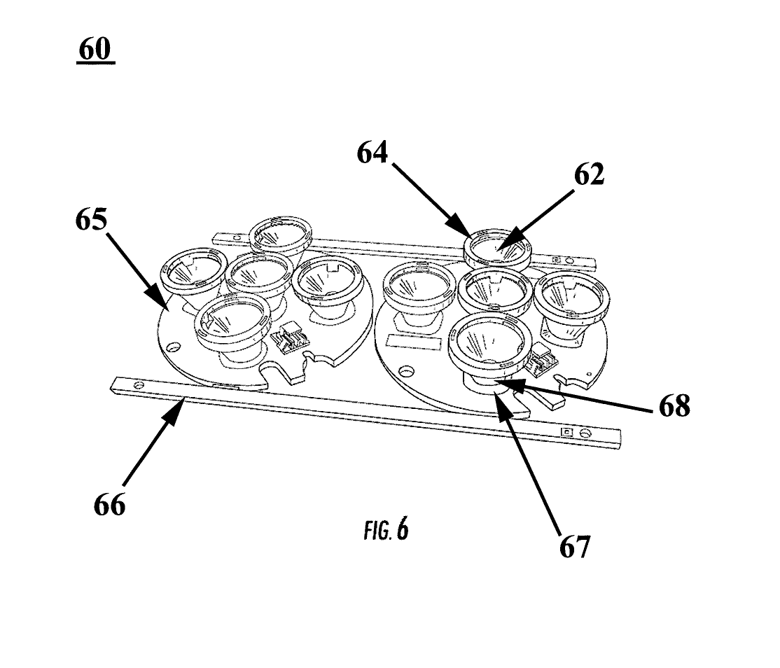

FIG. 6 illustrates a LED assembly (60) and method within the scope of the present invention with the LED assembly (60) having multiple lenses (not shown) or lens holders (64) with attached lenses (62). In particular, FIG. 6 illustrates the dispensed adhesive material (67) around the LED base (68) and attachment of the lens holder (64). The LED assembly (60) is optionally low heat cured. As shown in FIG. 6, the LED assembly (60) comes in a panelized form (66). The method of the present invention uses computer programmed coating equipment to selectively dispense the adhesive material, preferably by controlling or varying the type of needle dispensing valves. FIG. 6 illustrates an LED assembly having, for example, five lens holders (64) and lenses (62) attached on each of two printed circuit boards (65). As illustrated, the adhesive material (67) is consistently or uniformly applied to the printed circuit board (65) in the outlined shape of the lens holder (64). In this method of application, a clear conformal coating is not needed because the adhesive material has completely sealed the lens or lens holder with attached lens to the printed circuit board without migrating any material over the LED top light emitting surface (not shown). The amount of adhesive material is determined depending upon factors such as the end use application and dispensed to allow the adhesive material to cover the base of the LED and to seal the LED from contamination.

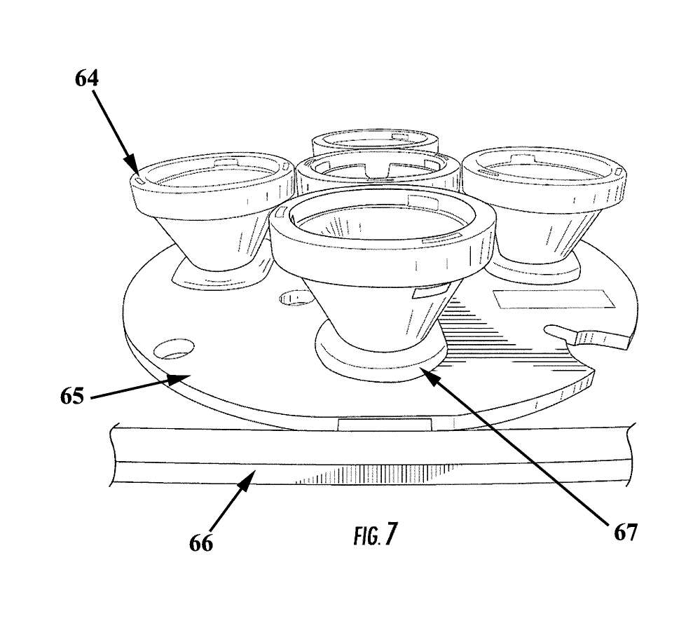

FIG. 7 is a close-up side view of an LED assembly 60 which is on a panel (66) showing an adhesive material (67) applied in accordance with the present invention to the surface of the printed circuit board (65) and the lens holder (64) securely attached to the LED package (not shown). This applied adhesive material provides the needed mechanical strength and protection from contamination.

The present invention purports to address and solve the problems associated with dispensing an adhesive material to bond an optical lens to a LED package and offers protection for the life of the LED. By precisely dispensing the adhesive around the LED, a protective seal is formed between the LED and the printed circuit board. Controlled and precise application of the silicone or epoxy adhesive by computer programmed selective dispensing equipment eliminates migration of the adhesive onto the LED. It is virtually impossible to do this by the current hand application method. Current adhesives do not offer protection from moisture or contaminants as does the adhesive material of the present invention. The adhesive material of the present invention is heat cured at a low temperature.

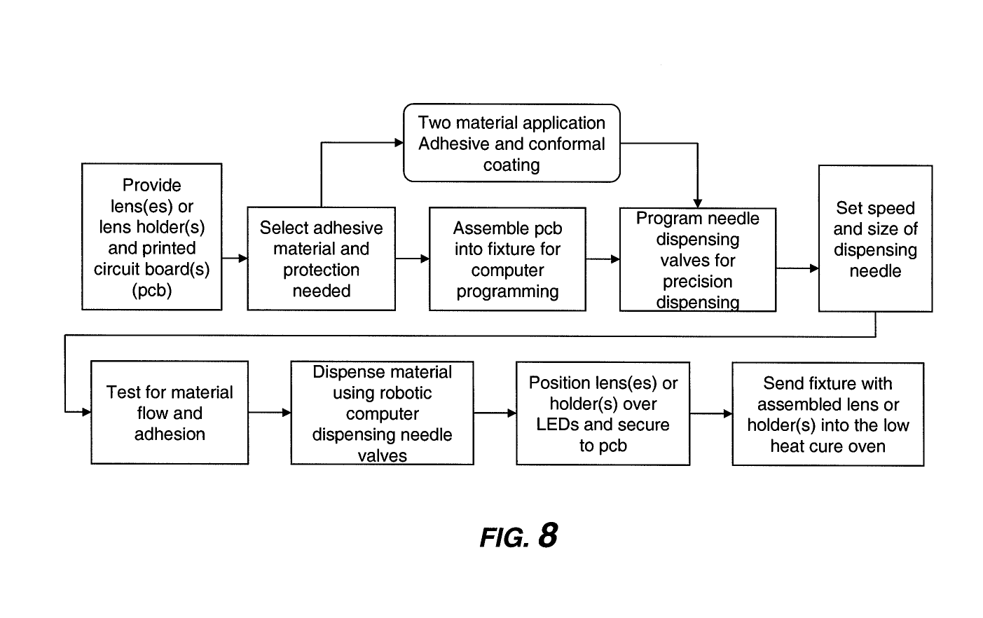

FIG. 8 is a process flow diagram illustrating the method(s) of application in accordance with the present invention. The method of the present invention includes the application of all types of lens holders and lenses to LEDs and OLEDs mounted on all types printed circuit boards. The board and lenses are typically received in an unattached state. One of ordinary skill in the art would readily know without undue experimentation which material is needed for a given application.

To apply the adhesive material, the needle dispensing valves of the selective coating equipment are programmed to precisely apply the material to the needed areas around the base of the lens or lens holder to be attached. The lenses or holders are assembled by hand or through the use of custom fixtures designed to hold multiple lenses or lens holders. Once the lenses or lens holders are assembled over the LED, the assembly is then transferred into a controlled heat curing oven to eliminate or reduce the risk of deforming the lenses or lens holders. The adhesive material is preferably cured under 230° F. for a period of about 20 to 30 minutes after dispensing to the outlined shape of the lens or lens holder that is being attached to the printed circuit board thereby forming an optical assembly.

In another aspect of the method of the present invention, the method provides for dispensing a conformal coating, preferably an optically clear, non-yellowing conformal coating, inside of the adhesive material for situations, for example, in which additional protection from contamination is needed. Thus, the method further comprises providing an optically clear, non-yellowing conformal coating and an adhesive material, applying the adhesive material to the printed circuit board, and applying the optically clear, non-yellowing conformal coating material adjacent to or on the perimeter of, preferably on the inside perimeter of, the adhesive material where each are applied prior to a low temperature heat cure. The adhesive material is applied on the printed circuit board to the perimeter of the lens or lens holder and creates a dam to contain the second application of the optically clear conformal coating. The conformal coating material is unique in that it can be applied over the LEDs or migrate on to them and not have detrimental effects on the lighting output.

Examples of conformal coatings suitable for use with the method of the present invention include, but are not limited to, silicone coatings such as the commonly owned inventions of co-pending U.S. patent application Ser. No. 12/799,238, filed Apr. 21, 2010, and co-pending U.S. patent application Ser. No. 13/104,842, filed May 10, 2011, each of which is incorporated herein by reference. A silicone adhesive provides a dual function of securing the lens or lens holder to the printed circuit board and offer protection from the effects of harsh environments, extreme heat up to 400° F. and contamination.

### EXAMPLE

An attached lens pull test was conducted. The equipment used was an Ametek Mechanical Force Gauge model L-20-M. The epoxy adhesive material used in testing was PROTAVIC ATE 10120, commercially available from Protavic America, Inc. The force (lbs) represents the amount of force to pull off attached lenses mounted on a printed circuit board.

| Samples | Non-Glued | Glued |
|---|---|---|
| 1 | 10 lbs | 21 lbs |
| 2 | 9.8 lbs | 18.5 lbs |
| 3 | 10.2 lbs | 22.5 lbs |

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

We claim:

1. A method for attaching an optical lens to a printed circuit board having an electronic light source, the method comprising:
applying an adhesive material to a printed circuit board using an automated adhesive dispensing machine, and
attaching an optical lens or an optical lens holder to the applied adhesive material forming an assembly.

2. The method according to claim 1, further comprising heat curing the assembly.

3. The method according to claim 1, wherein the electronic light source is a light-emitting diode or an organic light-emitting diode.

4. The method according to claim 1, wherein the adhesive material comprises a silicone, an epoxy, or a combination thereof.

5. The method according to claim 4, wherein the adhesive material is optically clear.

6. The method according to claim 4, wherein the adhesive material is non-yellowing.

7. The method according to claim 4, wherein the adhesive material comprising silicone has a viscosity in a range of about 50,000 centipoise to 70,000 centipoise.

8. The method according to claim 4, wherein the adhesive material comprising epoxy has a viscosity in a range of about 15,000 centipoise to 35,000 centipoise.

9. The method according to claim 4, wherein the epoxy has a shear strength greater than 5.0 MPa as tested using method NFT 76107.

10. The method according to claim 1, wherein the adhesive material is applied by precisely dispensing the adhesive material through a needle dispensing valve.

11. The method according to claim 10, wherein the adhesive material is dispensed through a pressurized needle dispensing valve.

12. The method according to claim 2, wherein the assembly is heat cured to a temperature at or below 110° C.

13. The method according to claim 1, wherein the silicone adhesive material further comprises a crystalline silica, an organopolysiloxane or mixture thereof, or a combination thereof.

14. The method according to claim 1, wherein the organopolysiloxane is a straight-chain organopolysiloxane.

15. A LED assembly comprising:
a printed circuit board having an electronic light source,
a lens or a lens holder with attached lens, and
an adhesive material applied to the printed circuit board around the lens or a base of the lens holder, the adhesive material comprising a silicone, an epoxy, or a combination thereof.

16. The LED assembly according to claim 15, wherein the adhesive material is optically clear.

17. The LED assembly according to claim 15, wherein the adhesive material is non-yellowing.

18. The LED assembly according to claim 15, wherein the silicone adhesive material further comprises a crystalline silica, an organopolysiloxane or mixture thereof, or a combination thereof.

19. The LED assembly according to claim 18, wherein the organopolysiloxane is a straight-chain organopolysiloxane.

20. A LED assembly comprising:
a printed circuit board having an electronic light source,
a lens or lens holder with attached lens,
an adhesive material precisely applied to the printed circuit board around the lens or a base of the lens holder, and
a conformal coating applied adjacent to or on the perimeter of the adhesive material on the printed circuit board around the lens or the base of the lens holder.

21. The LED assembly according to claim 20, wherein the adhesive material is heat cured.

22. The LED assembly according to claim 20, wherein the adhesive material comprises a silicone, an epoxy, or a combination thereof.

23. The LED assembly according to claim 22, wherein the silicone adhesive material further comprises a crystalline silica, an organopolysiloxane or mixture thereof, or a combination thereof.

24. The LED assembly according to claim 23, wherein the organopolysiloxane is a straight-chain organopolysiloxane.

25. The LED assembly according to claim 20, wherein the conformal coating comprises silicone.

26. The LED assembly according to claim 25, wherein the conformal coating is non-yellowing.

27. The LED assembly according to claim 25, wherein the conformal coating is optically clear.
